(19) United States
(12) Patent Application Publication
(10) Pub. No.: US 2025/0051876 A1
(43) Pub. Date: Feb. 13, 2025

(54) METHOD OF RECYCLING ALUMINUM SCRAP AND APPARATUS FOR RECYCLING ALUMINUM SCRAP

(71) Applicant: HONDA MOTOR CO., LTD., Tokyo (JP)

(72) Inventor: Takahiro MIZUKAMI, Saitama (JP)

(21) Appl. No.: 18/675,172

(22) Filed: May 28, 2024

(30) Foreign Application Priority Data
Aug. 9, 2023 (JP) 2023-130421

(51) Int. Cl. C22B 21/00

(52) U.S. Cl. CPC C22B 21/0092

(57) ABSTRACT

A method of recycling aluminum scrap by using a molten salt having a larger specific gravity than the liquid phase of aluminum, the method comprising: separating a phase of a molten material of an aluminum-containing component included in the aluminum scrap from a phase of the molten salt containing impurities included in the aluminum scrap.

This application is based on and claims the benefit of priority from Japanese Patent Application No. 2023-130421, filed on 9 Aug. 2023, the content of which is incorporated herein by reference.

### BACKGROUND OF THE INVENTION

### Field of the Invention

The present invention relates to a method of recycling aluminum scrap, and an apparatus for recycling aluminum scrap.

### Related Art

In recent years, there have been active efforts for achieving substantial waste reduction by controlling, reducing, recycling, and reusing waste. To this end, methods of recycling aluminum scrap have been under intense research and development.

Patent Document 1 describes a method of recycling Al alloy, the method comprising: a preparation step of preparing a first molten metal by melting an Fe·Mn containing material containing Fe and Mn, and an Al alloy raw material; a crystallization step of crystallizing Fe compounds from the first molten metal; an extraction step of extracting a second molten metal having at least a part of the Fe compounds crystallized from the first molten metal removed.
Patent Document 1: Japanese Unexamined Patent Application, Publication No. 2020-111808

### SUMMARY OF THE INVENTION

However, according to the method of recycling Al alloy described in Patent Document 1, the second molten metal remains in contact with the crystallized Fe compounds during extraction. Consequently, the Fe compounds can not be sufficiently removed. Therefore, the concentration of the Fe compounds in the resulting recycled Al alloy cannot sufficiently be reduced.

An object of the present invention is to provide a method of recycling aluminum scrap and an apparatus for recycling aluminum scrap, the method and the apparatus enabling sufficient reduction in the concentration of impurities.

A first aspect of the present disclosure relates to a method of recycling aluminum scrap by using a molten salt having a larger specific gravity than a liquid phase of aluminum, the method including: separating a phase of a molten material of an aluminum-containing component included in the aluminum scrap from a phase of the molten salt containing impurities included in the aluminum scrap.

A second aspect of the present disclosure relates to the method of recycling aluminum scrap as described in the first aspect, including: charging a molten material of the aluminum scrap into a funnel-shaped container having a tubular portion placed into the molten salt; and cooling the molten material of the aluminum scrap charged into the funnel-shaped container to crystallize the impurities, and then allowing the crystallized impurities to fall into the molten salt.

A third aspect of the present disclosure relates to the method of recycling aluminum scrap as described in the first aspect, including: cooling the molten material of the aluminum scrap to crystallize the impurities, and then performing solidification to obtain a solidified material; charging the solidified material to the molten salt; and heating the solidified material charged into the molten salt to melt the aluminum-containing component for allowing flotation on the molten salt.

A fourth aspect of the present disclosure relates to the method of recycling aluminum scrap as described in the first aspect, including: placing aluminum melt on the molten salt; charging the aluminum scrap into the aluminum melt; and heating the aluminum scrap charged into the aluminum melt to melt the aluminum-containing component and allowing the impurities to fall into the molten salt.

A fifth aspect of the present disclosure relates to the method of recycling aluminum scrap as described in any one of the first to fourth aspects, in which the molten salt has a specific gravity of 2.50 or more and 3.60 or less.

A sixth aspect of the present disclosure relates to the method of recycling aluminum scrap as described in any one of the first to fifth aspects, in which the molten salt contains one or more elements selected from the group consisting of Cs, Ba, Rb, Sr, and Ag.

A seventh aspect of the present disclosure relates to an apparatus for recycling aluminum scrap, including: a melting furnace containing a molten salt having a larger specific gravity than a liquid phase of aluminum; a funnel-shaped container having a tubular portion placed into the molten salt; a charger for charging a molten material of aluminum scrap into the funnel-shaped container; and a cooler for cooling the molten material of the aluminum scrap charged into the funnel-shaped container so that impurities included in the aluminum scrap crystallize, and then the crystallized impurities fall into the molten salt.

An eighth aspect of the present disclosure relates to an apparatus for recycling aluminum scrap, including: a cooler for cooling a molten material of aluminum scrap so that solidification after impurities included in the aluminum scrap crystallize yields a solidified material; a melting furnace containing a molten salt having a larger specific gravity than a liquid phase of aluminum; and a charger for charging the solidified material into the molten salt, the melting furnace heating the solidified material charged into the molten salt so that an aluminum-containing component included in the aluminum scrap melts and floats on the molten salt.

A ninth aspect of the present disclosure relates to an apparatus of recycling aluminum scrap, including: a melting furnace having a bottom and containing a molten salt having a larger specific gravity than a liquid phase of aluminum and aluminum melt in this order from the bottom; and a charger for charging aluminum scrap into the aluminum melt, the melting furnace heating the aluminum scrap charged into the aluminum melt so that an aluminum-containing component included in the aluminum scrap melts and impurities included in the aluminum scrap fall into the molten salt.

The present invention can provide a method of recycling aluminum scrap and an apparatus for recycling aluminum scrap, the method and the apparatus enabling sufficient reduction in the concentration of impurities.

### BRIEF DESCRIPTION OF THE DRAWINGS

FIG. 1 shows a schematic diagram illustrating an example of the apparatus for recycling aluminum scrap according to the present embodiment;

FIGS. 2A and 2B show schematic diagrams illustrating a method of recycling aluminum scrap by using the apparatus for recycling aluminum scrap in FIG. 1;

FIG. 3 shows a graph illustrating an example of the relationship between the specific gravities of the liquid and solid phases of aluminum and the solid phase of impurities and temperature;

FIG. 4 shows a schematic diagram illustrating another example of the apparatus for recycling aluminum scrap according to the present embodiment;

FIG. 5 show schematic diagrams illustrating a method of recycling aluminum scrap by using the apparatus for recycling aluminum scrap in FIG. 4;

FIG. 6 shows a schematic diagram illustrating another example of the apparatus for recycling aluminum scrap according to the present embodiment;

FIG. 7 show schematic diagrams illustrating a method of recycling aluminum scrap by using the apparatus for recycling aluminum scrap in FIG. 6; and

FIG. 8 shows a schematic diagram illustrating a variation of the apparatus for recycling aluminum scrap in FIG. 6.

### DETAILED DESCRIPTION OF THE INVENTION

Below, the embodiments of the present invention will be described with reference to the drawings.

The method of recycling aluminum scrap according to the present embodiment is a method of recycling aluminum scrap by using a molten salt having a larger specific gravity than the liquid phase of aluminum, the method comprising: separating a phase of a molten material of an aluminum-containing component included in the aluminum scrap from a phase of a molten salt containing impurities included in the aluminum scrap. This can suppress elution and contamination of impurities into the aluminum-containing component, thereby sufficiently reducing the concentration of impurities in the recycled aluminum. Therefore, recycled aluminum can be used for, for example, expanded materials and casting materials. Moreover, impurities can be separated without using a filter.

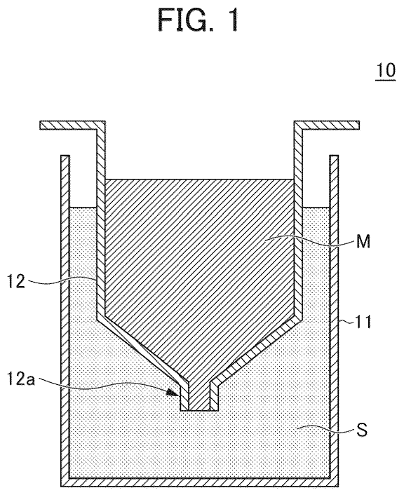

FIG. 1 shows an example of the apparatus for recycling aluminum scrap according to the present embodiment.

An apparatus 10 for recycling aluminum scrap comprises a melting furnace 11 containing a molten salt S having a larger specific gravity than the liquid phase of aluminum; a funnel-shaped container 12 having a tubular portion 12a placed into the molten salt S; and a molten-material charger for charging a molten material M of the aluminum scrap into the funnel-shaped container 12. The apparatus 10 for recycling aluminum scrap also comprises a cooler for cooling the molten material M of the aluminum scrap charged into the funnel-shaped container 12 so that impurities included in the molten material M of the aluminum scrap crystallize and then the crystallized impurities fall into the molten salt S. In this case, the melting furnace 11 is heated so that the molten salt S melts. The molten material M of the aluminum scrap is charged into the funnel-shaped container 12 so that the self weight thereof is balanced with a buoyancy received from the molten salt S.

There is no particular limitation for the molten-material charger as long as the molten material M of the aluminum scrap can be charged into the funnel-shaped container 12, but examples include known automatic pourers.

There is no particular limitation for the cooler as long as the molten material M of the aluminum scrap charged into the funnel-shaped container 12 can be cooled, but examples include known air coolers.

As used in the present specification and claims, the cooling includes natural cooling.

Next, a method of recycling aluminum scrap using an apparatus 10 for recycling aluminum scrap will be described.

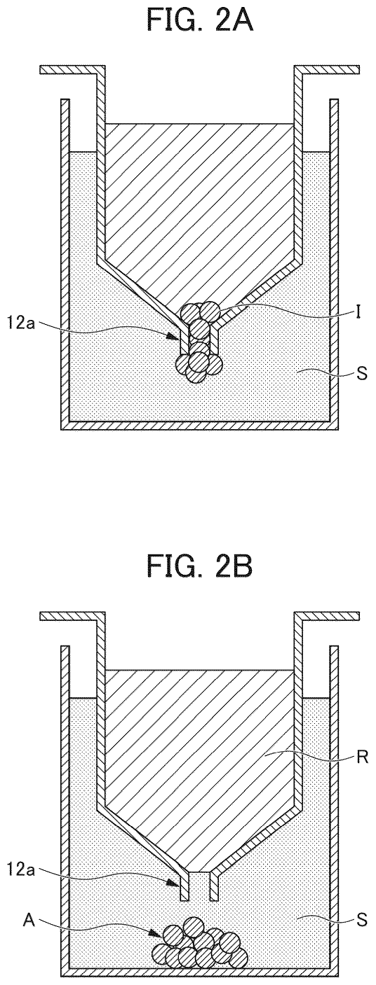

First, aluminum scrap is heated and melted at a temperature of 700° C. or more (for example, 750° C.) to obtain a molten material M of the aluminum scrap. Next, after the molten material M of the aluminum scrap is charged into a funnel-shaped container 12 having a tubular portion 12a placed into the molten salt S, the molten material M of the aluminum scrap charged into the funnel-shaped container 12 is cooled at a cooling rate of, for example, 0.7° C./min. As a result, impurities I crystallize at a temperature of 700° C. or less, and agglomerate in the tubular portion 12a (see FIG. 2A). At this time, the impurities I has a larger specific gravity than the molten salt S, and thus the molten salt S enters between the tubular part 12a and the impurities I. As the crystallized amount of the impurities I further increases, the self weight of an agglomerate A of the impurities becomes larger than the surface tension. This can cause the agglomerate A of the impurities falls from the tubular portion 12a into the molten salt S (see FIG. 2B). Next, recycled aluminum R as an aluminum-containing component is solidified at a temperature of 560° C. or less. Finally, the funnel-shaped container 12 containing the solidified recycled aluminum R is removed from the melting furnace 11. The agglomerate A of the impurities falling into the molten salt S is also removed using, for example, a wire mesh.

Examples of the aluminum scrap include, for example, scrap of aluminum parts having volts fastened or press-fit. The impurities I include, for example, one or more elements selected from the group consisting of Si, Mn, Fe, Cu.

It is noted that if the impurities I are difficult to crystallize, one or more elements selected from the group consisting of Fe, Mn, Cr, V, and Si may be added to the molten material M of the aluminum scrap to adjust the composition of the molten material M of the aluminum scrap. At this time, the sludge factor may be taken into consideration. For example, when the composition of the molten material M of the aluminum scrap is adjusted so as to include Fe (1.0 mass %), Mn (1.6 mass %), Cr (0.25 mass %), V (0.60 mass %), and Si (7.0 mass %) as impurities, the impurities I may crystallize at a temperature of 700° C. or less.

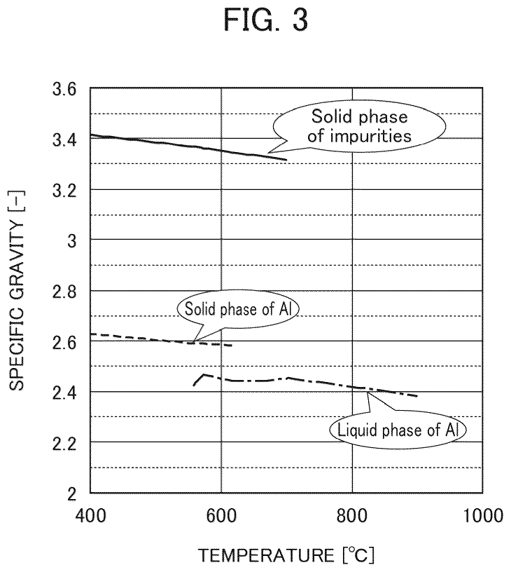

FIG. 3 shows an example of the relationship between the specific gravities of the liquid and solid phases of aluminum and the solid phase of impurities and temperature. Here, the impurities consist of Al, Fe, Mn, Cr, V, and Si, and presumably have an Mn₄Al₁₆Si₃ type crystal structure at ordinary temperature.

The specific gravity of the molten salt S is preferably 2.50 or more and 3.60 or less, more preferably 2.70 or more and 3.10 or less. When the specific gravity of the molten salt S is 2.50 or more, the molten salt S nay be difficult to move into the molten material M of the aluminum scrap. When the specific gravity is 3.60 or less, the agglomerate A of the impurities can easily fall into the molten salt S. Here, the specific gravity of the liquid phase of aluminum is 2.45.

The melting point of the molten salt S is preferably 750° C. or less, more preferably 550° C. or less. When the melting point of the molten salt S is 750° C. or less, the agglomerate A of the impurities can easily fall into the molten salt S. It is noted that the melting point of the molten salt S is, for example, 530° C. or more.

The molten salt contains, for example, one or more elements selected from the group consisting of Cs, Ba, Rb, Sr, and Ag. Specific examples of the molten salt S include, for example, mixtures of BaCl₂, CaCl₂, and LiCl.

Table 1 shows the relationships between the formulations of the mixtures of BaCl₂, CaCl₂, and LiCl and the specific gravities at 570° C.

TABLE 1

| Formulation [mol %] | | | |
|---|---|---|---|
| BaCl₂ | CaCl₂ | LiCl | Specific gravity |
| 35 | 45 | 20 | 2.64 |
| 35 | 35 | 30 | 2.62 |
| 35 | 25 | 40 | 2.61 |

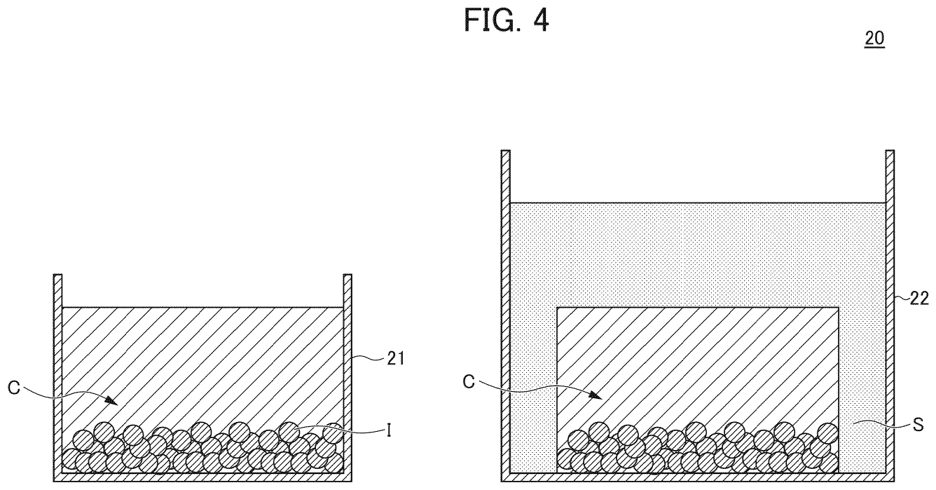

FIG. 4 shows another example of the apparatus for recycling aluminum scrap according to the present embodiment.

An apparatus 20 for recycling aluminum scrap comprises a molten-material charger for charging a molten material of aluminum scrap into a cylindrical mold 21; and a cooler for cooling the molten material of the aluminum scrap charged into the cylindrical mold 21 so that solidification after impurities I included in the molten material of the aluminum scrap crystallize yields a solidified material C. The apparatus 20 for recycling aluminum scrap also comprises a melting furnace 22 containing a molten salt S having a larger specific gravity than the liquid phase of aluminum; and a solidified-material charger for charging the solidified material C into the molten salt S. Here, the melting furnace 22 is heated so that the molten salt S melts, and then the solidified material C charged into the molten salt S is heated so that an aluminum-containing component included in the solidified material C melts and floats on the molten salt S.

There is no particular limitation for the molten-material charger as long as the molten material M of the aluminum scrap can be charged into the cylindrical mold 21, but examples include known automatic pourers.

There is no particular limitation for the cooler as long as the molten material of the aluminum scrap contained in the cylindrical mold 21 can be cooled, but examples include known air coolers.

There is no particular limitation for the solidified-material charger as long as the solidified material C can be charged into the molten salt S, but examples include known automatic charger.

Next, a method of recycling aluminum scrap using an apparatus 20 for recycling aluminum scrap will be described.

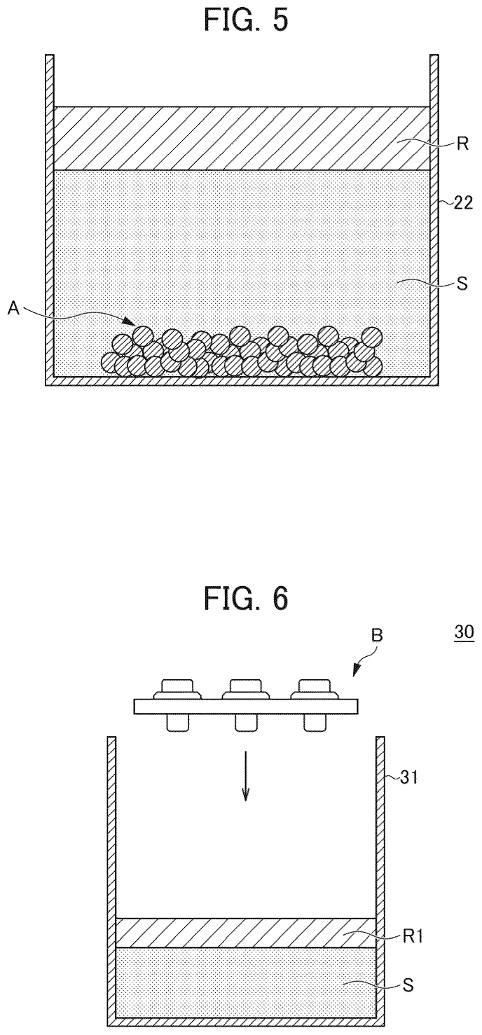

First, aluminum scrap is heated and melted at a temperature of 700° C. or more to obtain a molten material of the aluminum scrap. Next, after the molten material of the aluminum scrap is charged into the cylindrical mold 21, the molten material of the aluminum scrap charged into the cylindrical mold 21 is cooled at a cooling rate of, for example, 0.5° C./min. As a result, the impurities I crystallize at a temperature of 600° C. or less and agglomerate at the bottom of the cylindrical mold 21. Next, the molten material of the aluminum scrap solidifies at 560° C. or less to yield a solidified material C. Next, after the solidified material C is charged into the molten salt S, the solidified material C charged into the molten salt S is heated. As a result, the recycled aluminum R as an aluminum-containing component melts at a temperature of 560° C. or more and floats on the molten salt S (see FIG. 5). At this time, the agglomerate A of the impurities does not melt, and thus remains at the bottom of the melting furnace 22. Finally, the molten recycled aluminum R is discharged from the upper part of the melting furnace 22. After the agglomerate A of the impurities remaining at the bottom of the melting furnace 22 is heated and melted at a temperature of 700° C. or more, and then discharged from a lower part of the melting furnace 22.

FIG. 6 shows another example of the apparatus for recycling aluminum scrap according to the present embodiment.

An apparatus 30 for recycling aluminum scrap comprises a melting furnace 31 having a bottom and containing a molten salt S having a larger specific gravity than the liquid phase of aluminum and aluminum melt R1 in this order from the bottom; and a scrap charger for charging aluminum scrap B into aluminum melt R1. Here, after the melting furnace 31 is heated so that the molten salt S and the aluminum melt R1, the aluminum scrap B charged into the aluminum melt R1 is heated so that an aluminum-containing component included in the aluminum scrap B melts, and impurities included in the aluminum scrap B fall into the molten salt S.

There is no particular limitation for the scrap charger as long as the aluminum scrap B can be charged into the aluminum melt R1, but examples include known automatic chargers.

Next, a method of recycling aluminum scrap using an apparatus 30 for recycling aluminum scrap will be described.

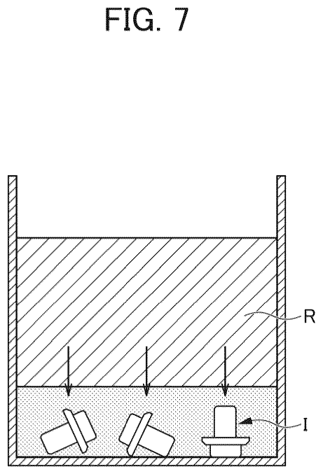

First, after the aluminum scrap B is charged into the aluminum melt R1, the aluminum scrap B charged into the aluminum melt R1 is heated. As a result, an aluminum-containing component melts in the aluminum melt R1 to yield recycled aluminum R at a temperature of 560° C. or more. The aluminum scrap B from which the aluminum-containing component is melted out, i.e., the impurities I has a larger specific gravity than the recycled aluminum R, and thus falls into the molten salt S (see FIG. 7). Finally, the recycled aluminum R is discharged from the upper part of the melting furnace 31. The impurities I falling into the molten salt S is also removed using, for example, a wire mesh.

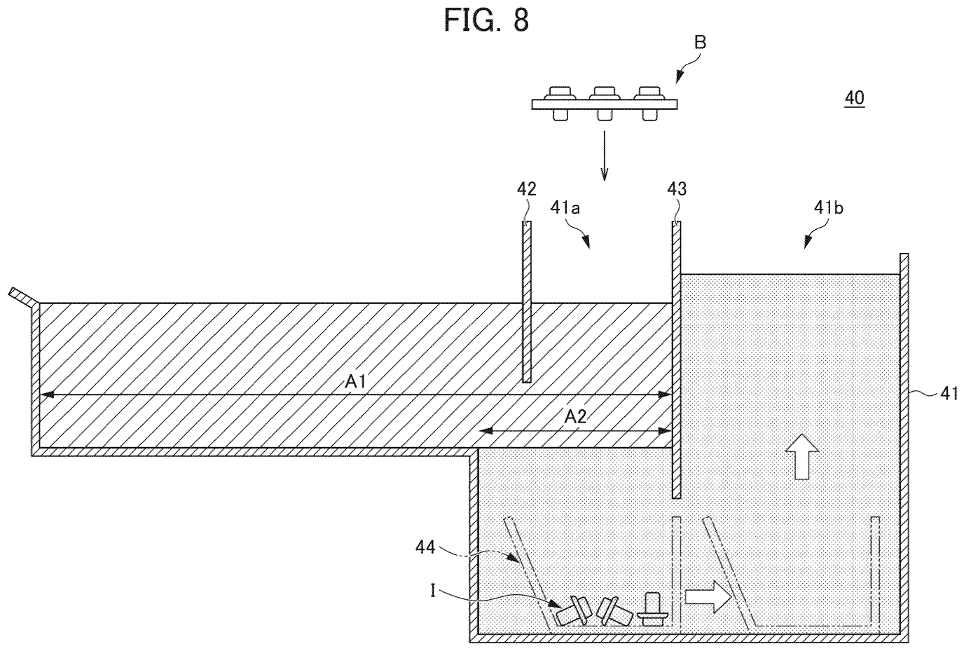

FIG. 8 shows a variation of the apparatus 30 for recycling aluminum scrap.

An apparatus 40 for recycling aluminum scrap is similar to the apparatus 30 for recycling aluminum scrap except that a melting furnace 41 is used instead of the melting furnace 31, the melting furnace 41 having an area A1 of a region where the aluminum melt R1 is contained larger than an area A2 of a region where the molten salt S is contained, and having an inlet 41a and an outlet 41b. Here, the inlet 41a is a region through which the aluminum scrap B is charged, and the outlet 41b is a region through which the impurities I are removed. The apparatus 40 for recycling aluminum scrap also has partitions 42 and 43 to compartmentalize the inlet 41a and the outlet 41b, respectively. Further, a container 44 (e.g., a wire mesh container) having a through hole is movably placed at the bottom of the melting furnace 41. Therefore, the impurities I falling into the molten salt S can be received by the container 44, and the container 44 can be horizontally and then vertically moved to remove the impurities I.

Although the embodiments of the present invention are described as above, the present invention is not limited to the above embodiments, and the above embodiments may be modified as appropriate within the scope of the spirits of the present invention.

### EXAMPLES

Below, Examples of the present invention will be described, but the present invention shall not be limited to these Examples

### Example 1

The apparatus 30 for recycling aluminum scrap (see FIG. 6) was used to recycle the aluminum scrap B. Specifically, after the aluminum scrap B was charged into the aluminum melt R1, the aluminum scrap B charged into the aluminum melt R1 was heated for 1 hour. The aluminum scrap B used for this includes 6 kg of aluminum sashes having Fe-containing screws as impurities. As the molten salt S and the aluminum melt R1, used were 1.8 Kg of molten salt consisting of BaCl₂ (38 mol %), CaCl₂ (44 mol %), and LiCl (18 mol %) and having a specific gravity of 2.6 at 750° C. and 2.5 kg of pure aluminum. Both were in a molten state at 750° C. Finally, the recycled aluminum R was discharged from the upper part of the melting furnace 31. Here, the specific gravity of the molten salt was actually measured by the maximum bubble pressure method.

### Comparative Example 1

The aluminum scrap B was recycled as in Example 1 except that the molten salt S was not used.

### [Concentration of Impurities]

ICP emission spectrochemical analysis was used to analyze the concentration of Fe in the recycled aluminum.

Results from analyzing the concentration of Fe in the recycled aluminum are shown in Table 2.

TABLE 2

| | Concentration of Fe in recycled |
|---|---|
| | aluminum [mass %] |
| Example 1 | 0.30 |
| Comparative Example 1 | 0.35 |

Table 2 indicates that Example 1 has a concentration of Fe in the recycled aluminum lower than Comparative Example 1 in which the molten salt was not used.

### [Preparation of Molten Material of Aluminum Scrap]

After an aluminum alloy (A356.2) as aluminum scrap was heated and melted at 750° C., the composition of a molten material M of the aluminum scrap was adjusted by adding a master alloy containing Fe, Mn, Cr, V and Si. As analyzed by using ICP emission spectrochemical analysis, the composition of the molten material M of the aluminum scrap was found to be Si (6.3 mass %), Fe (0.84 mass %), Mn (1.6 mass %), Cr (0.22 mass %), V (0.36 mass %), and Al (remainder).

### Example 2

The apparatus 10 for recycling aluminum scrap (see FIG. 1) was used to recycle aluminum scrap. Specifically, after a molten material of the aluminum scrap was charged into the funnel-shaped vessel 12 having the tubular portion 12a placed into the molten salt S so that the self weight thereof was balanced with a buoyancy received from the molten salt S, the molten material M of the aluminum scrap charged into the funnel-shaped container 12 was cooled to 560° C. at a cooling rate of 0.7° C./min. For this, 3.5 Kg of molten salt consisting of BaCl₂ (38 mol %), CaCl₂) (44 mol %), and LiCl (18 mol %) and having a specific gravity of 2.6 at 750° C., which was in a molten state at 750° C., was used as the molten salt S. As a result, the recycled aluminum R was solidified, and the funnel-shaped container 12 containing the solidified recycled aluminum R was removed from the melting furnace 11. At this time, the agglomerate A of the impurities had fallen into the molten salt S. The concentration of Fe in the recycled aluminum was analyzed, and found to be 0.34 mass %. This demonstrates that the concentration of Fe in the recycled aluminum was sufficiently reduced.

### Example 3

The apparatus 20 for recycling aluminum scrap (see FIG. 4) was used to recycle aluminum scrap. Specifically, after 4.2 kg of a molten material of the aluminum scrap was charged into the cylindrical mold 21, the molten material of the aluminum scrap charged into the cylindrical mold 21 was cooled to 560° C. at a cooling rate at 0.5° C./min. As a result, the impurities I crystallized and agglomerated at the bottom of the cylindrical mold 21. The molten material of the aluminum scrap also solidified to yield a solidified material C. Next, after the solidified material C was charged into the molten salt S, the solidified material C charged into the molten salt S was heated. For this, 6.0 Kg of molten salt consisting of BaCl₂ (38 mol %), CaCl₂) (44 mol %), and LiCl (18 mol %) and having a specific gravity of 2.7 at 650° C., which was in a molten state at 650° C., was used as the molten salt S. As a result, the recycle aluminum R melted and floated on the molten salt S. At this time, the agglomerate A of the impurities did not melt, and thus remained at the bottom of the melting furnace 22. Finally, the molten recycled aluminum R is discharged from the upper part of the melting furnace 22. The concentration of Fe in the recycled aluminum was analyzed, and found to be 0.24 mass %. This demonstrates that the concentration of Fe in the recycled aluminum was sufficiently reduced.

### EXPLANATION OF REFERENCE NUMERALS

10, 20, 30, 40 Apparatus for recycling aluminum scrap
11, 22, 31, 41 Melting furnace
12 Funnel-shaped container
12a Tubular portion
21 Cylindrical mold
41a Inlet
41b Outlet
42, 43 Partition
44 Container
A Agglomerate of impurities
B Aluminum scrap
C Solidified material
I Impurities
M Molten material of aluminum scrap
R Recycled aluminum
R1 Aluminum melt
S Molten salt

What is claimed is:

1. A method of recycling aluminum scrap by using a molten salt having a larger specific gravity than a liquid phase of aluminum, the method comprising:
separating a phase of a molten material of an aluminum-containing component included in the aluminum scrap from a phase of the molten salt containing impurities included in the aluminum scrap.

2. The method of recycling aluminum scrap according to claim 1, comprising: charging a molten material of the aluminum scrap into a funnel-shaped container having a tubular portion placed into the molten salt; and
cooling the molten material of the aluminum scrap charged into the funnel-shaped container to crystallize the impurities, and then allowing the crystallized impurities to fall into the molten salt.

3. The method of recycling aluminum scrap according to claim 1, comprising: cooling the molten material of the aluminum scrap to crystallize the impurities, and then performing solidification to obtain a solidified material;
charging the solidified material to the molten salt; and
heating the solidified material charged into the molten salt to melt the aluminum-containing component for allowing flotation on the molten salt.

4. The method of recycling aluminum scrap according to claim 1, comprising: placing aluminum melt on the molten salt;
charging the aluminum scrap into the aluminum melt; and
heating the aluminum scrap charged into the aluminum melt to melt the aluminum-containing component and allowing the impurities to fall into the molten salt.

5. The method of recycling aluminum scrap according to claim 1, wherein the molten salt has a specific gravity of 2.50 or more and 3.60 or less.

6. The method of recycling aluminum scrap according to claim 1, wherein the molten salt contains one or more elements selected from the group consisting of Cs, Ba, Rb, Sr, and Ag.

7. An apparatus for recycling aluminum scrap, comprising: a melting furnace containing a molten salt having a larger specific gravity than a liquid phase of aluminum;
a funnel-shaped container having a tubular portion placed into the molten salt;
a charger for charging a molten material of aluminum scrap into the funnel-shaped container; and
a cooler for cooling the molten material of the aluminum scrap charged into the funnel-shaped container so that impurities included in the aluminum scrap crystallize, and then the crystallized impurities fall into the molten salt.

8. An apparatus for recycling aluminum scrap, comprising: a cooler for cooling a molten material of aluminum scrap so that solidification after impurities included in the aluminum scrap crystallize yields a solidified material;
a melting furnace containing a molten salt having a larger specific gravity than a liquid phase of aluminum; and
a charger for charging the solidified material into the molten salt,
the melting furnace heating the solidified material charged into the molten salt so that an aluminum-containing component included in the aluminum scrap melt and floats on the molten salt.

9. An apparatus of recycling aluminum scrap, comprising: a melting furnace having a bottom and containing a molten salt having a larger specific gravity than a liquid phase of aluminum and aluminum melt in this order from the bottom; and
a charger for charging aluminum scrap into the aluminum melt,
the melting furnace heating the aluminum scrap charged into the aluminum melt so that an aluminum-containing component included in the aluminum scrap melts, and impurities included in the aluminum scrap fall into the molten salt.
